(19) United States
(12) Patent Application Publication
(10) Pub. No.: US 2008/0121082 A1
(43) Pub. Date: May 29, 2008

(54) Cutting device and laser module for use therewith

(75) Inventors: David M. Smith, Simpsonville, SC (US); Anthony M. Sorrells, Pickens, SC (US)

Correspondence Address: BRINKS HOFER GILSON & LIONE, P.O. BOX 10395, CHICAGO, IL, 60610, US

(73) Assignee: Eastway Fair Company Limited

(21) Appl. No.: 11/595,422

(22) Filed: Nov. 8, 2006

(51) Int. Cl. B26D 7/27; G01C 15/00

(52) U.S. Cl. 83/522.11; 33/286

(57) ABSTRACT

A rotating blade-type cutting device, such as a miter saw, and a laser module for use with the cutting device. The laser module includes a housing rotating in unison with the saw blade, a laser generator positioned within the housing so as to emit a laser beam therefrom, and a power source positioned within the housing. The power source is removable from the housing while the housing is coupled with the saw blade so that the power source is easily accessible to the saw operator.

The present invention relates to a rotating blade-type saw, such as a miter saw, and a laser module for use with the saw. More specifically, the present invention relates to a laser module having a housing that facilitates easy access to the laser module power supply.

### BACKGROUND OF THE INVENTION

Rotating saws, such as miter saws, are typically used to cut wood and other materials at precise lengths and angles. Miter saws generally include a base for supporting a workpiece to be cut, an arm extending upwardly from the base, and a saw head assembly pivotally connected to the arm. The saw head assembly includes a rotating spindle, a power source for driving the spindle, and a blade supported by the spindle so as to rotate in unison therewith. During use, the operator activates the power source to rotate the blade and lowers the saw head assembly towards the base, thereby cutting the area of workpiece between the blade cutting edges (commonly known as the kerf). When the cut is intended for a specific location along the workpiece, the operator typically marks the workpiece and attempts to align the saw blade with the mark before making the cut. To improve the alignment of the blade with respect to the mark on the workpiece, currently known saws often include laser alignment devices that project a laser beam onto the top surface of the workpiece.

### BRIEF SUMMARY OF THE INVENTION

The present invention includes a laser module for use with a rotating blade-type cutting device, such as a miter saw circular saw and the like. The laser module includes a housing coupled with the saw blade so that the housing rotates in unison with the saw blade, a laser generator positioned within the housing so as to emit a laser beam therefrom, and a power source positioned within the housing and configured to supply electricity to the laser generator. The power source is removable from the housing while the housing is coupled with the saw blade so that the power source is easily accessible to the saw operator.

In one aspect of the present invention, the housing includes an inner cover coupled with the saw blade and an outer cover cooperating with the inner cover to define a housing cavity for supporting the power source. The outer cover may include a removable battery cover supporting the power source and a laser cover generally aligned with the laser generator. The battery cover is coupled with the inner cover by a first mounting connection and the laser cover is coupled with the inner cover by a second mounting connection that is independent of the first mounting connection so that the battery cover is removable while the inner cover and the battery cover are coupled with the saw blade. The inner cover may include a blade washer portion mounted against the saw blade and a central hub extending from the blade washer portion to provide structural support for the housing.

In another aspect, the laser module includes a housing having a first portion coupled with the saw blade and a second portion that is removable from the first portion of the housing while the first portion is coupled with the saw blade. The second portion of the housing supports the power source so that the power source is removable from the first portion of the housing while the first portion of the housing is coupled with the saw blade. The power source may include a plurality of batteries nested within (or removably attached to) the second portion of the housing. The housing may include a third portion secured to the first portion and generally aligned with the laser generator.

In yet another aspect, the laser module includes a housing having a first portion coupled with the saw blade and a second portion that is coupled with the first portion to define a cavity. The first portion of the housing includes a blade washer portion mounted to the saw blade and a central hub extending from the blade washer portion and defining a mounting surface and the second portion of the housing defines an opening generally aligned with the central hub so that the mounting surface is exposed to the exterior of the laser module when the second portion of the housing is coupled with the first portion. The central hub may extend substantially across the thickness of the laser module.

In another aspect of the present invention, a cutting device includes a base for supporting a workpiece and a saw head assembly pivotally connected to the base for cutting the workpiece. The saw head assembly includes a rotating spindle, a saw blade and a laser module mounted on the spindle, and a motor driving the spindle. The laser generator includes a housing mounted on the spindle and a laser generator and a power source supported by the housing, where the power source is removable from the housing.

### BRIEF DESCRIPTION OF THE DRAWINGS

FIG. 1 is a partial cross-sectional view of a miter saw having a laser module embodying the principles of the present invention;

FIG. 2 is a top perspective of the laser module shown in FIG. 1;

FIG. 3a is a top perspective view of an inner cover of the laser module shown in FIG. 2;

FIG. 3b is a bottom perspective view of an inner cover of the laser module shown in FIG. 2;

FIG. 4 is a side perspective view of the two-piece inner cover of the laser module shown in FIG. 3; and

FIG. 5 is a side perspective view of a flexure bracket shown in FIG. 4.

### DETAILED DESCRIPTION OF THE INVENTION

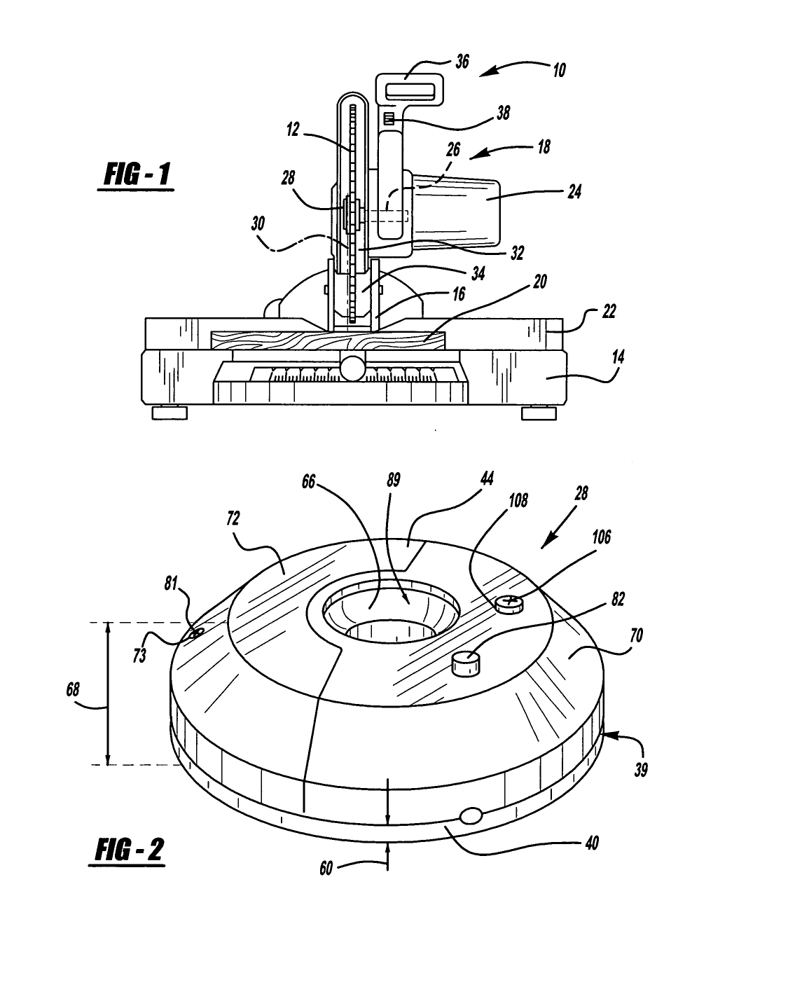

Referring now to the drawings and initially to FIG. 1, a rotating blade-type cutting device, such as a miter saw 10 is shown. The miter saw 10 generally includes a base 14, an arm 16 extending upwards from the base 14, and a saw head assembly 18 pivotally supported by the arm 16 and configured to rotate a saw blade 12 with respect to the base 14. The base 14 includes a flat surface for supporting a workpiece 20 and a fence 22 against which the workpiece 18 may be held in a desired position, such as perpendicular to the saw blade 12. The saw head assembly 18 includes a motor assembly 24, a shaft 26 rotated by the motor assembly 24, a laser module 28 for mounting the circular saw blade 12 to the shaft 26 and projecting an indicator beam 30 toward the workpiece 20, a fixed guard 32 and a movable shield 34 generally positioned around the saw blade 12 for shielding purposes, a handle 36 for moving the saw head assembly 18 with respect to the arm 16, and a power switch 38 for activating the motor assembly 24. The pivotable connection between the saw head assembly 18 and the arm 16 may include a spring (not shown) for biasing the saw head assembly 18 out of engagement with the workpiece 20. Although the saw 10 shown in FIG. 1 is a compound miter saw having a miter angle adjustment mechanism and a tilt adjustment mechanism, the invention is equally applicable to any other suitable cutting device such as a simple miter saw, a sliding compound miter saw, a chop saw, or the like.

During operation, when ready to make a cut, the operator grips the handle 36 and lowers the saw head assembly 18 down toward the workpiece 20 while depressing the power switch 38 and actuating the motor assembly 24. When the saw head assembly 18 is lowered to a sufficient position, the rotating saw blade 12 cuts the workpiece 20.

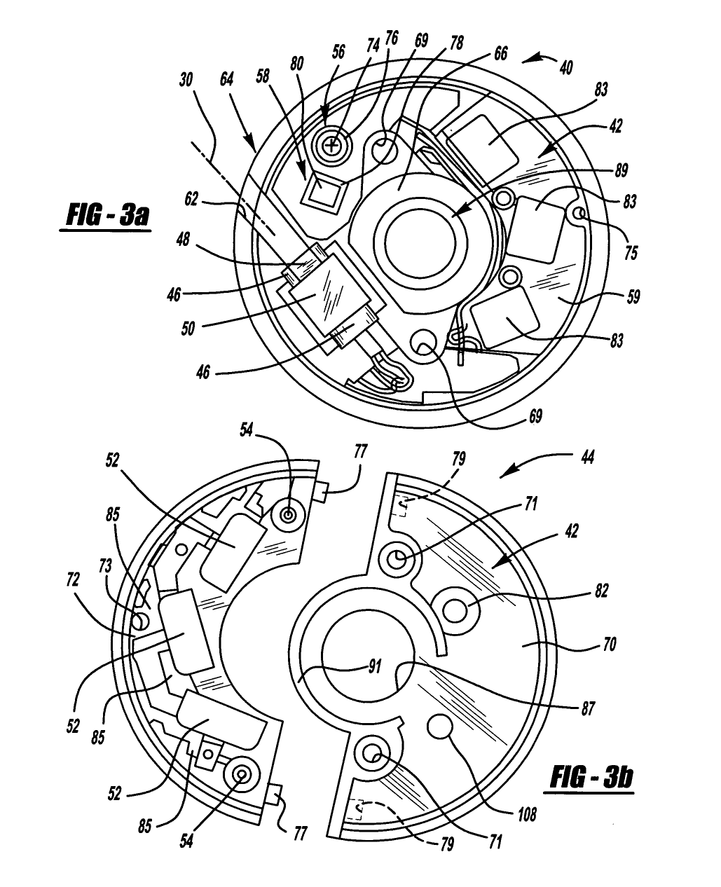

Referring now to FIGS. 2, 3a, and 3b, the laser module 28 includes a housing 39 having an inner cover 40 with a surface adjacent a face of the saw blade 12 and a two-piece outer cover 44 that cooperates with the inner cover 40 to define a cavity 42 for housing the components of the laser module 28. For example, referring to FIGS. 3a and 3b, the laser module 28 includes the following components: a laser generator 46 that emits light, a lens 48 for focusing the light into the indicator beam 30, a flexure bracket 50 for adjustably supporting the laser generator 46 within the cavity 42, a plurality of batteries 52 and electrical connectors 54 for supplying electricity to the laser generator 46, and a centrifugal switch 56 and an on/off switch 58 for selectively activating the laser generator 46.

The inner cover 40 may be made of any suitable material but is generally made of metal. The inner cover 40 includes a blade washer portion 59 that engages a face of the saw blade 12 and a central hub 66 extending from the blade washer portion 59. The blade washer portion 59 of the inner cover 40 has a relatively small thickness 60 to minimize the lateral distance between the indicator beam 30 and the face of the saw blade 12. Furthermore, the blade washer portion 59 of the inner cover 40 includes a laser beam channel 62 extending from the lens 48 to a perimeter 64 of the inner cover 40 to further reduce the lateral distance between the indicator beam 30 and the face of the saw blade 12. This configuration permits the indicator beam 30 to be substantially parallel to the face of the saw blade 12 when intersecting the workpiece 20. The central hub 66 extends substantially completely across the thickness 68 of the laser module 28 to strengthen the laser module 28. More specifically, when the laser module 28 is mounted to the saw blade 12, the central hub 66 completely bears the compression forces acting on the laser module 28 and prevents the plastic outer cover 44 and the components within the cavity 42 from experiencing such forces, as will be discussed further below.

As shown in FIG. 3b, the outer cover 44 is a two-piece cover having a laser cover 70 positioned over the laser generator 46 and a battery cover 72 positioned over the one or more batteries 52. The laser cover 70 and the battery cover 72 are each independently connected to the inner cover 40 so that the battery cover 72 is removable from the inner cover 40 without requiring the removal of the laser cover 70 and without dismounting of the laser module 28 from the saw blade 12. For example, the laser cover 70 is secured to the inner cover 40 by a pair of fasteners (not shown) that each extend through a pair of openings 69 in the inner cover 40 and are received by threaded openings 71 formed in the laser cover 70. Additionally, the battery cover 72 is independently secured to the inner cover 40 by a fastener 81 (FIG. 2) that extends through an opening 73 in the battery cover 72 and is received by a threaded opening 75 formed in the inner cover 40.

The battery cover 72 is further secured to the inner cover 40 by a tab-slot connection with the laser cover 70. More specifically, the battery cover includes a pair of tabs 77 that are received within slots 79 formed on a face of the laser cover 70. The head of the fastener 81 abuts a collar portion of the opening 73 formed in the battery cover 72 so that the fastener 81 is accessible from the outboard side of the laser module 28. Therefore, as mentioned above, the battery cover 72 is removable from the inner cover 40 without requiring the removal of the laser cover 70 and without dismounting of the laser module 28 from the saw blade 12. This configuration simplifies access to the batteries 52 and reduces the time and effort required to replace the batteries 52.

The battery cover 72 includes a plurality of support tabs 85 that provide support for the batteries 52 within the battery cover 72. More specifically, the support tabs 85 define cavities that correspond to the size of the batteries 52 so that the batteries 52 are nested within or removably attached to the battery cover 72. Additionally, the inner cover 40 includes a plurality of indentations 83 having a generally arcuate shape and being aligned with the support tabs 85 so that the batteries engage the blade washer portion 59 and provide an electrical connection between the batteries and the blade washer portion 59 when the laser module 28 is assembled 28. The batteries 52 are relatively small, such as the type of batteries that would be suitable for a wrist watch, and are spaced from each other such that the weight of the laser module 28 is substantially balanced.

The laser cover 70 defines an opening 87 generally aligned with the central hub 66 so that the central hub 66 completely bears the compression forces when the laser module 28 is mounted to the saw blade 12, thereby protecting the plastic outer cover 44 and the components within the cavity 42 from experiencing such forces. For example, a mounting bolt or a shoulder portion of the shaft 26 abuts a mounting surface 89 of the central hub 66 to secure the laser module 28 to the saw blade 12. The opening 87 in the laser cover 70 is larger than the mounting surface 89 so that the mounting bolt or the shaft 26 is able to directly abut the mounting surface 89. Additionally, the mounting surface 89 may have a generally tapered shape so as to mate with a tapered surface of the mounting bolt or the shaft 26. The laser cover 70 also defines an annular wall 91 extending substantially completely around the central hub 66 so as to seal the cavity 42 and protect the laser generator 46 from particulates and other contamination even when the battery cover 72 has been removed from the inner cover 40.

As mentioned above, the laser generator 46 and the lens 48 cooperate to generate a dot-like laser beam that is emitted from the laser module 28 as the indicator beam 30. As a result of the rotation of the laser module 28, the indicator beam 30 appears as an indicator line (not shown) extending across a top surface of the workpiece 20 in a direction that is parallel to the saw blade 12. The laser generator 46 is connected to the inner cover 40 by the flexure bracket 50. The flexure bracket 50 is flexible to permit adjustment of the alignment of the indicator beam 30, as will be discussed in further detail below. Although a laser generator is disclosed in the figures, any suitable light source may be used to generate the indicator line on the workpiece, such as a light emitting diode (LED) or a focused electric light bulb.

The batteries 52, the blade washer portion 59, and the electrical connectors 54 define an electrical circuit that is selectively closed by the centrifugal switch 56 and/or the on/off switch 58. In an alternative design, another type of electrical power supply may be used, such as an electro-magnetic generator that utilizes the rotational motion of the laser module 28 to generate power. The centrifugal switch 56 and the on/off switch 58 are each wired in series with the batteries 52 and the laser generator 46 so that the laser generator 46 is only activated when one or both of the switches 56, 58 is in a closed position. The centrifugal switch 56 includes a small metal spring 74 positioned within a metal cylinder 76 in such a manner that the spring 74 does not engage the walls of the cylinder 74 when the spring 74 is in an undeflected position so that the centrifugal switch 56 is in an open position. Upon rotation of the laser module 28, however, centrifugal forces cause the spring 74 to deflect and engage the walls of the cylinder 74, thereby closing the centrifugal switch 56 and completing the electrical circuit between the batteries 52 and the laser generator 46. The centrifugal switch 56 reduces the likelihood of accidental activation of the laser generator 46, thereby increasing the battery life and potentially reducing the likelihood of laser-related injuries.

Because the position of the laser generator 46 can only be adjusted while the laser module is stationary, as will be discussed in more detail below, the on/off switch 58 is provided to selectively activate the laser generator 46 when the laser module 28 is stationary. The on/off switch 58 includes a housing 78 connected to the inner cover 40, an actuator 80 slidably positioned within the housing 78 so as to be movable between contracted and extended positions, a spring (not shown) to urge the actuator 80 towards the extended position, and a rubber cap 82 positioned on the top of the actuator 80 and extending through an opening in the outer cover 44 so as to be accessible to the saw operator. The bottom of the actuator 80 includes a metal connector so that the on/off switch 58 is open when the actuator 80 is in the extended position and is closed when the actuator 80 is in the contracted position. The on/off switch 58 is connected in parallel with the centrifugal switch 56 so that the closure of either switch 56, 58 completes the electrical circuit between the batteries 52 and the laser generator 46.

As mentioned above, the laser generator 46 is connected to the inner cover 40 by the flexure bracket 50, which is flexible so that the alignment of the laser generator 46 is adjustable with respect to the housing 39. This configuration permits the saw operator to properly align the location of the indicator line on the workpiece 20 with respect to the saw blade 12 and the kerf.

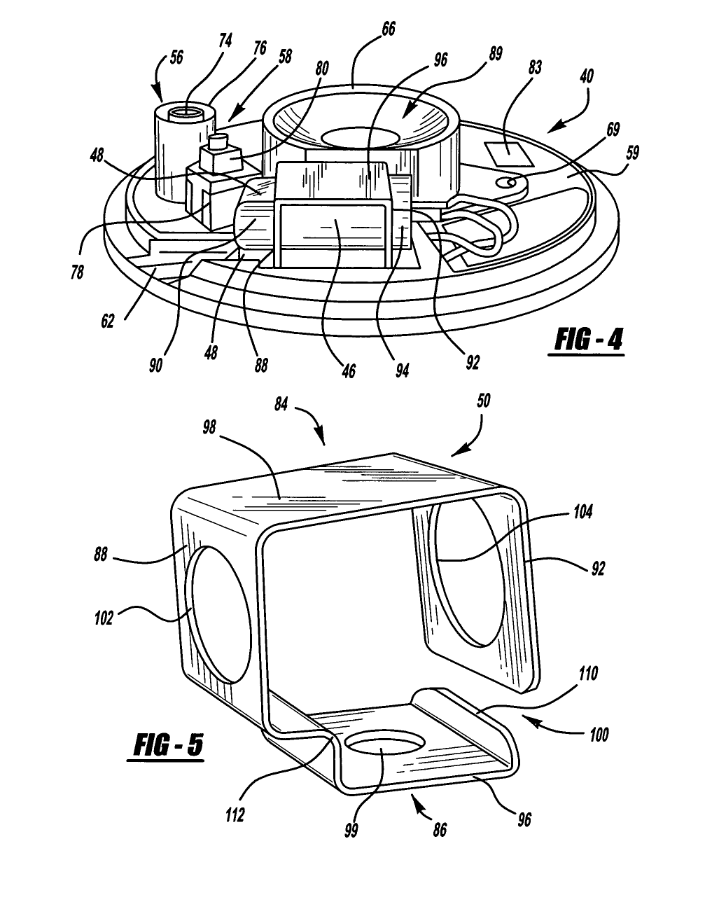

Referring to FIGS. 4 and 5, the flexure bracket 50 in one embodiment includes a support portion 84 supporting the laser generator 46 and a connector portion 86 connected to the inner cover 40. The support portion 84 is movable with respect to the connector portion 86 so that the alignment of the laser generator 46 can be adjusted with respect to the housing 39. For example, the support portion 84 includes: a first arm 88 supporting one end portion 90 of the laser generator 46, a second arm 92 supporting the other end portion 94 of the laser generator 46, and a third arm 98 connecting the first and second arms 88, 92 with each other. The connector portion 86 includes a fourth arm 96 connected to the first arm 84 and to the inner cover 40. However, the second arm 92 only extends a portion of the distance between the third and fourth arms 98, 96 so that a gap 100 exists between the second and fourth arms 92, 96 and the support portion 84 and connector portion 86 are movable with respect to each other. The first and second arms 88, 92 are generally parallel with each other and the third and fourth arms 98, 96 are generally parallel with each other so that the flexure bracket 50 is a substantially closed, rectangular shape.

As mentioned above, the first arm 88 supports one end 90 of the laser generator 46 and the second arm 92 supports the other end 94 of the laser generator 46. This configuration maximizes the distance between the first and second arms 88, 92 and provides stability between the points of connection for the laser generator 46 so that the location of the indicator line on the workpiece 20 remains substantially constant unless the flexure bracket 50 is actively adjusted.

Each of the first and second arms 88, 92 include an opening 102, 104 for receiving a respective end portion 90, 94 of the laser module 46. The laser generator 46 may be press-fit within the respective openings 102, 104. An additional securing means, however, such as an epoxy material or a mechanical fastener, may be provided between the respective components 46, 50. Additionally, the fourth arm 96 includes an opening 99 for mounting the fourth arm 96 to the inner cover 40 with a mechanical fastener or with another type of securing means such as an epoxy material.

An adjustment screw 106 extends through the outer cover 44 and is in threaded engagement with an opening 108 defined by the outer cover 44. The adjustment screw 106 abuts the third arm 98 of the flexure bracket 50 to control the position thereof. Therefore, rotation of the adjustment screw 106 adjusts the depth of the adjustment screw 106 within the laser module 28 and the alignment of the laser generator 46 with respect to the housing 39. More specifically, as the adjustment screw 106 is advanced into the housing 39, the gap 100 between the second and fourth arms 92, 96 of the flexure bracket becomes smaller and the path of the indicator beam 30 becomes angled outwardly, in a direction away from the saw blade 12. Therefore, the location of the indicator line on the workpiece 20 can be adjusted with respect to the saw blade 12 by rotating the adjustment screw 106. The operator is therefore able to adjust the indicator line to lie on a desired point of the workpiece 20, such as along the kerf or between the respective kerf.

The flexure bracket 50 may be made of a sheet metal material that is designed to permit flexing upon movement of the adjustment screw 106 and to prevent flexing when the adjustment screw 106 is not moving. Additionally, the fourth arm 98 includes a stop portion 110 to limit the range of motion of the second arm and a step portion 112 to promote flexing at the base of the first arm 88 upon movement of the adjustment screw 106. Furthermore, the adjustment screw 106 includes a means for facilitating rotation, such as a head portion that mates with a screwdriver or an alien wrench.

While the invention has been described in conjunction with specific embodiments it is to be understood that many alternatives, modifications, and variations will be apparent to those skilled in the art in light of the foregoing detailed description. It is therefore intended that the foregoing description be regarded as illustrative rather than limiting, and that it be understood that it is the following claims, including all equivalents, that are intended to define the spirit and scope of this invention.

What is claimed:

1. A laser module for use with a cutting device having a rotating saw blade, the laser module comprising:
a housing coupled with the saw blade so that the housing and the saw blade rotate in unison;
a laser generator supported by the housing and configured to emit a laser beam from the laser module; and
a power source supported by the housing and configured to supply electricity to the laser generator, the power source being configured to be removable from the housing while at least a portion of the housing is coupled with the saw blade.

2. The laser module of claim 1, the housing including an inner cover configured to be coupled with the saw blade and an outer cover cooperating with the inner cover to define a cavity for supporting the power source.

3. The laser module of claim 2, the outer cover including a battery cover supporting the power source and configured to be removable from the inner cover while the inner cover is coupled with the saw blade.

4. The laser module of claim 3, the battery cover including at least one support tab for supporting the power source.

5. The laser module of claim 3, the outer cover further including a laser cover having a portion generally aligned with the laser generator.

6. The laser module of claim 5, the battery cover coupled with the inner cover by a first mounting connection and the laser cover coupled with the inner cover by a second mounting connection that is independent of the first mounting connection.

7. The laser module of claim 2, the inner cover including a blade washer portion configured to engage the saw blade and a central hub extending from the blade washer portion to provide structural support for the housing.

8. The laser module of claim 1, the housing including a securing portion configured to selectively permit removal of the power source from the housing while the at least one portion of the housing is coupled with the saw blade.

9. A laser module for use with a cutting device having a rotating saw blade, the laser module comprising:
a housing coupled with the saw blade so that the housing and the saw blade rotate in unison, the housing including a first portion configured to be coupled with the saw blade and a second portion configured to be removable from the first portion of the housing while the first portion is coupled with the saw blade; and
a laser generator supported by the housing and configured to emit a laser beam from the laser module.

10. The laser module of claim 9, further comprising a power source supported by the housing and configured to supply electricity to the laser generator.

11. The laser module of claim 10, the power source supported by the second portion of the housing so that the power source is removable from the first portion of the housing while the first portion of the housing is coupled with the saw blade.

12. The laser module of claim 11, the power source including a plurality of batteries supported by the second portion of the housing.

13. The laser module of claim 12, the housing further including a third portion secured to the first portion and generally aligned with the laser generator.

14. The laser module of claim 13, the second portion of the housing further secured to the third portion by a tab-slot connection.

15. The laser module of claim 9, the first portion of the housing including a blade washer portion configured to engage the saw blade and a central hub extending from the blade washer portion to provide structural support for the housing.

16. A laser module for use with a cutting device having a rotating saw blade, the laser module comprising:
a housing including a first portion configured to be coupled with the saw blade so that the housing and the saw blade rotate in unison and a second portion coupled with the first portion to define a cavity;
a laser generator positioned within the cavity and configured to emit a laser beam from the housing; and
a power source positioned within the cavity and configured to supply electricity to the laser generator;
the first portion of the housing including a blade washer portion configured to be coupled with the saw blade and a central hub extending from the blade washer portion away from the saw blade and defining a mounting surface, and
the second portion of the housing defining an opening generally aligned with the central hub so that the mounting surface is exposed to the exterior of the laser module when the second portion of the housing is coupled with the first portion.

17. The laser module of claim 15, the central hub extending substantially completely across a thickness of the laser module.

18. The laser module of claim 16, the mounting surface of the central hub having a generally tapered shape.

19. The laser module of claim 15, the first portion of the housing is made of a first material and the second portion of the housing is made of a second material having a material strength substantially lower than that of the first material.

20. A cutting device comprising:
a base configured to support a workpiece; and
a saw head assembly pivotally connected to the base, the saw head assembly including a rotatable spindle, a saw blade mounted on the spindle, a laser module mounted on the spindle such that the spindle, the saw blade, and the laser module are configured to rotate in unison, and a motor configured to rotatably drive the spindle;
the laser generator including:
a housing mounted on the spindle;
a laser generator supported by the housing and configured to emit a laser beam from the laser module; and
a power source supported by the housing and configured to supply electricity to the laser generator, the power source being configured to be removable from the housing while at least a portion of the housing is coupled with the saw blade.
